(19) United States
(12) Patent Application Publication
(10) Pub. No.: US 2015/0365698 A1
(43) Pub. Date: Dec. 17, 2015

(54) Method and Apparatus for Prediction Value Derivation in Intra Coding

(71) Applicant: MEDIATEK INC., Hsin-Chu, Taiwan (CN)

(72) Inventors: Jian-Liang LIN, Su'ao Township, Yilan County (TW); Yi-Wen CHEN, Taichung City (TW)

(21) Appl. No.: 14/762,498

(22) PCT Filed: Mar. 26, 2014
(86) PCT No.: PCT/CN2014/074130

§ 371 Date: Jul. 22, 2015

Related U.S. Application Data
(60) Provisional application No. 61/810,797, filed on Apr. 11, 2013.

(51) Int. Cl. H04N 19/593; H04N 19/176; H04N 19/157; H04N 19/597; H04N 19/105

(52) U.S. Cl. CPC H04N 19/593; H04N 19/597; H04N 19/105; H04N 19/157; H04N 19/176

(57) ABSTRACT

A method and apparatus for sample-based Simplified Depth Coding (SDC) are disclosed. The system determines prediction samples for the current depth block based on reconstructed neighboring depth samples according to a selected Intra mode and determines an offset value for the current depth block. The final reconstructed samples are derived by adding the offset value to each of the prediction samples. The offset value corresponds to a difference between a reconstructed depth value and a predicted depth value for the current depth block. The offset value can be derived from the residual value, and the residual value can be derived implicitly at a decoder side or transmitted in the bitstream. The selected Intra mode may correspond to Planar mode, the prediction samples are derived according to the Planar mode.

### CROSS REFERENCE TO RELATED APPLICATIONS

The present invention is a National Phase Application of PCT Application No. PCT/CN2014/074130, filed on Mar, 26, 2014, which claims priority to U.S. Provisional Patent Application, Ser. No. 61/810,797, filed on Apr. 11, 2013, entitled “Methods of Deriving the Predicting Value in Intra Coding”. The priority applications are hereby incorporated by reference in their entireties.

### FIELD OF INVENTION

The present invention relates to three-dimensional and multi-view video coding. In particular, the present invention relates to depth coding using Simplified Depth Coding.

### BACKGROUND OF THE INVENTION

Three-dimensional (3D) television has been a technology trend in recent years that is targeted to bring viewers sensational viewing experience. Multi-view video is a technique to capture and render 3D video. The multi-view video is typically created by capturing a scene using multiple cameras simultaneously, where the multiple cameras are properly located so that each camera captures the scene from one viewpoint. The multi-view video with a large number of video sequences associated with the views represents a massive amount data. Accordingly, the multi-view video will require a large storage space to store and/or a high bandwidth to transmit. Therefore, multi-view video coding techniques have been developed in the field to reduce the required storage space and the transmission bandwidth. In three-dimensional and multi-view coding systems, the texture data as well as depth data are coded.

For depth map, the Simplified Depth Coding (SDC), which is also termed as Segment-wise DC Coding, is an alternative Intra coding mode. Whether SDC is used is signalled by a SDC flag at coding unit (CU) level. For SDC, the depth block is Intra predicted by a conventional Intra mode or depth modelling mode 1. The partition size of SDC-coded CU is always 2N×2N and therefore there is no need for signaling in the bitstream regarding the block size of SDC-coded CU. Furthermore, instead of coded as quantized transform coefficients, the SDC-coded residuals are represented by one or two constant residual values depending on whether the depth block is divided into one or two segments.

According to existing three-dimensional video coding based on HEVC (3D-HEVC), certain information is signalled for SDC-coded blocks. The information signalled includes:

1. type of segmentation/prediction of the current block. Possible values are
i. DC (Direct Current; 1 segment);
ii. DMM (Depth Modelling Modes) Mode 1—Explicit Wedgelets (2 segments);
iii. Planar (1 segment);

2. For the DMM, additional prediction information is coded.

3. For each resulting segment, a residual value (in the pixel domain) is signalled in the bitstream.

In the depth coding process, the depth residuals are mapped to limited depth values, which are present in the original depth map. The limited depth values are represented by a Depth Lookup Table (DLT). Consequently, residuals can be coded by signalling indexes pointing to entries of this lookup table. The depth values present in a depth map are usually limited to a number smaller than the total number that can be represented by a depth capture device. Therefore, the use of DLT can reduces the bit depth required for residual magnitudes. This mapping table is transmitted to the decoder so that the inverse lookup from an index to a valid depth value can be performed at the decoder.

At the encoder side, the residual index iᵣₑₛᵢ be coded into the bitstream, is determined according to:

iᵣₑₛᵢ=I(d_{orig})−I(d_{pred}); (1)

where d_{orig} denotes an original depth value determined for the depth block, d_{pred} denotes the predicting depth value, and I(.) denotes the Index Lookup Table. The computed residual index iᵣₑₛᵢ is then coded with a significance flag, a sign flag and with ┌log₂ d_{valid}┐ bits for the magnitude of the residual index, where d_{valid} denotes the number of valid depth values and ┌x┐ is a ceiling function corresponding to the smallest integer not less than x.

The Depth Lookup Table takes advantage of the sparse property of the depth map, where only a small number of depth values out of a full available depth range (e.g., 2⁸) will typically be present in the depth map. In the encoder, a dynamic depth lookup-table is constructed by analyzing a number of frames (e.g. one Intra period) of the input sequence. This depth lookup-table is used during the coding process to reduce the effective signal bit-depth of the residual signal.

In order to reconstruct the lookup table, the encoder reads a pre-defined number of frames from the input video sequence to be coded and scans all samples for presence of the depth values. During this process a mapping table is generated that maps depth values to existing depth values based on the original uncompressed depth map.

The Depth Lookup Table D(.), the index Lookup Table I(.), the Depth Mapping Table M(.) and the number of valid depth values d_{valid} are derived by the following process that analyses the depth map Dₜ:

1. Initialization
boolean vector B(d)=FALSE for all depth values d,
index counter i=0.

2. Process each pixel position p in Dₜ for multiple time instances t:
Set B(Dₜ(p))=TRUE to mark valid depth values.

3. Count the number of TRUE values in B(d). The result is set to the value for d_{valid}.

4. For each d with B(d)==TRUE:
Set D(i)=d,
Set M(d)=d,
Set I(d)=i, and
i=i+1.

5. For each d with B(d)==FALSE:
Find \hat{d}=arg min|d−\hat{d}| and B(d)==TRUE
Set M(d)=\hat{d}.

6. Set I(d)=(\hat{d}).

As mentioned above, there are three types of segmentation and prediction in the existing SDC. The respective processes for the three types of segmentation and prediction are described as follows.

### DC:

The DC prediction value (Predicting depth value (d_{pred})) is predicted from neighboring blocks using a the mean of all directly adjacent samples of the top and the left blocks. DMM Mode:

Edge information is defined by start/end side and corresponding index.

The DC prediction values (Predicting depth value (d_{pred})) for each segment are predicted by neighboring depth values as shown in FIG. 1. Two depth blocks (110 and 120) are shown in FIG. 1, where each block is divided into two segments as shown by the dashed line. The reconstructed neighboring depth samples for block 110 are indicated by references 112 and 114 and the reconstructed neighboring depth samples for block 120 are indicated by references 122 and 124.

### Planar:

Generate the predictors of the Planar mode as shown in FIG. 2. Linear interpolation is used to generate predictors for the right column and the bottom row as shown in FIG. 2A. For the right column, the linear interpolation is based on depth values at A and Z. For the bottom row, the linear interpolation is based on depth values at B and Z. After the right column and the bottom row are interpolated, the predictors for the rest of depth positions are bilinear interpolated using four respective depth samples from four sides as shown in FIG. 2B.

The DC prediction value (Predicting depth value (d_{pred})) is the mean of the predictors of the Planar mode.

In the above derivation processes, prediction sample refers to the predicted value generated by the Intra coding mode, which may be the DC mode, DMM Mode 1 or the Planar mode in the existing 3D-HEVC. The reconstruction process for the DC mode at the decoder side is illustrated in FIG. 3. The DC prediction value (Pred_{DC}) for the current depth block (310) is determined based on neighboring reconstructed depth values. In FIG. 3, the original depth values are shown in the current depth block (310). The residual value is obtained by applying inverse lookup on the residual index received. The reconstructed depth value (Rec_{DC}) for the current depth block is obtained by adding residual to Pred_{DC}. The reconstructed depth value (Rec_{DC}) is then used for all depth samples in the current reconstructed depth block (320).

The reconstruction process for the DMM Mode 1 at the decoder side is illustrated in FIG. 4. The current depth block (410) is divided into two segments. The DC prediction values (Pred_{DC1} and Pred_{DC2}) for the two segments of the current depth block (410) are determined based on respective neighboring reconstructed depth values. In FIG. 4, the original depth values are shown in the current depth block (410). The residual values (residual₁ and residual₂) are obtained by applying inverse lookup on the residual indexes received. The reconstructed depth values (Rec_{DC1} and Rec_{DC1}) for the two segments of the current depth block are obtained respectively by adding residual₁ to Pred_{DC1} and adding residual₂ to Pred_{DC2}. The reconstructed depth values (Rec_{DC1} and Rec_{DC1}) are then used for all depth samples in the two respective segments of current reconstructed depth block (420).

The reconstruction process for the Planar mode at the decoder side is illustrated in FIG. 5. The DC prediction value (Pred_{DC}) for the current depth block (510) is determined based on the mean of the predicted depth values for the current depth block. The predicted depth values for the current depth block are derived based on neighboring reconstructed depth values using linear interpolation (right column and bottom row) and bilinear interpolation (other depth samples). In FIG. 5, the original depth values are shown in the current depth block (510). The residual value is obtained by applying inverse lookup on the residual index received. The reconstructed depth value (Rec_{DC}) for the current depth block is obtained by adding residual to Pred_{DC}. The reconstructed depth value (Rec_{DC}) is then used for all depth samples in the current reconstructed depth block (520).

View synthesis prediction (VSP) is a technique to remove interview redundancies among video signal from different viewpoints, in which a synthetic signal is used as references to predict a current picture.

In 3D-HEVC Test Model, HTM-6.0, there exists a process to derive a disparity vector predictor, known as DoNBDV (Depth oriented Neighboring Block Disparity Vector). The disparity vector identified from DoNBDV is used to fetch a depth block in the depth image of the reference view. The fetched depth block has the same size as the current prediction unit (PU), and the fetched depth block is then used for backward warping for the current PU.

In addition, the warping operation may be performed at a sub-PU level precision, such as 2×2 or 4×4 blocks. A maximum depth value is selected for a sub-PU block and used for warping all the pixels in the sub-PU block. The VSP based on backward warping (BVSP) is applied in both texture and depth component coding.

In existing HTM-6.0, BVSP prediction is added as a new merging candidate to signal the use of BVSP prediction. When the BVSP candidate is selected, the current block may be a Skip block if there is no residual to transmit or a Merge block if there is residual information to be coded.

In the conventional SDC for depth block coding, a same predicted value is used for the whole depth block. Therefore, the reconstructed depth block always has a uniform value. Accordingly, the reconstructed depth block is very coarse and lack of details. It is desirable to develop a technique to improve the quality of the reconstructed depth data.

### SUMMARY OF THE INVENTION

A method and apparatus for sample-based Simplified Depth Coding (SDC), which is also termed as Segment-wise DC Coding, are disclosed. Embodiments according to the present invention encode or decode a residual value for a segment of the current depth block, determine prediction samples for the segment of the current depth block based on reconstructed neighboring depth samples according to a selected Intra mode, and derive an offset value from a residual value for the segment of the current depth block. The final reconstructed samples are reconstructed by adding the offset value to each of the prediction samples of the segment.

The offset value may correspond to the difference between the reconstructed depth value and the predicted depth value for the segment of the current depth block. The offset value may be derived from the residual value, wherein the residual value is derived implicitly at a decoder side or the residual value is transmitted in a bitstream. The offset value can be derived from a residual index according to an inverse Lookup Table.

The selected Intra mode may correspond to the Planar mode where the current depth block only includes one segment, the prediction samples are derived using linear interpolation and bilinear interpolation from the reconstructed neighboring depth samples of the current depth block according to the Planar mode, and the offset value is derived from the residual value or a residual index. The selected Intra mode can be selected from a set of Intra modes and the selection of the selected Intra mode from the set of Intra modes can be signalled in a bitstream. The set of Intra modes may correspond to {DC mode, DMM Mode 1, Planar mode} or {DC mode, DMM Mode 1, VSP}. The ordering of the Intra modes within the set can be changed. A truncated unary code can be used to indicate the selected Intra mode from the set of Intra modes.

### BRIEF DESCRIPTION OF THE DRAWINGS

FIG. 1 illustrates two examples of Depth Modelling Mode (DMM) for depth coding based on Simplified Depth Coding (SDC), where the depth block is divided into two segments and each segment is modelled as a uniform area.

FIG. 2 illustrates the linear interpolation and bilinear interpolation used to generate prediction samples for the depth block based on reconstructed neighboring depth samples according to the Planar mode in SDC.

FIG. 3 illustrates an exemplary reconstruction process for Simplified Depth Coding (SDC) using the DC mode.

FIG. 4 illustrates an exemplary reconstruction process for Simplified Depth Coding (SDC) using the Depth Modelling Mode (DMM) Mode 1.

FIG. 5 illustrates an exemplary reconstruction process for Simplified Depth Coding (SDC) using the Planar mode.

FIG. 6A illustrates that the reconstructed samples for the right column and the bottom row of the current depth block are formed by adding the predictors (210) of the Planar mode to an offset value (610).

FIG. 6B illustrates that the reconstructed samples for other sample positions of the current depth block are formed by adding the respective predictors (220) of the Planar mode to the offset value (610).

FIG. 7 illustrates an exemplary reconstruction process for sample-based Simplified Depth Coding (SDC) using the Planar mode according to an embodiment of the present invention.

FIG. 8 illustrates an exemplary flowchart for a system incorporating sample-based Simplified Depth Coding (SDC) using the Planar mode according to an embodiment of the present invention.

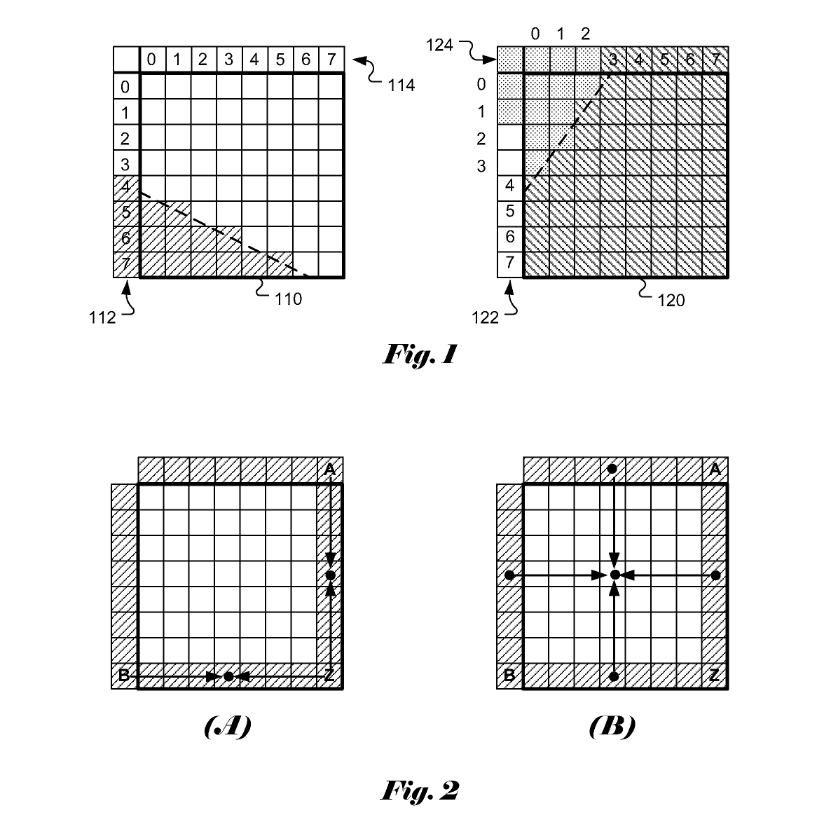

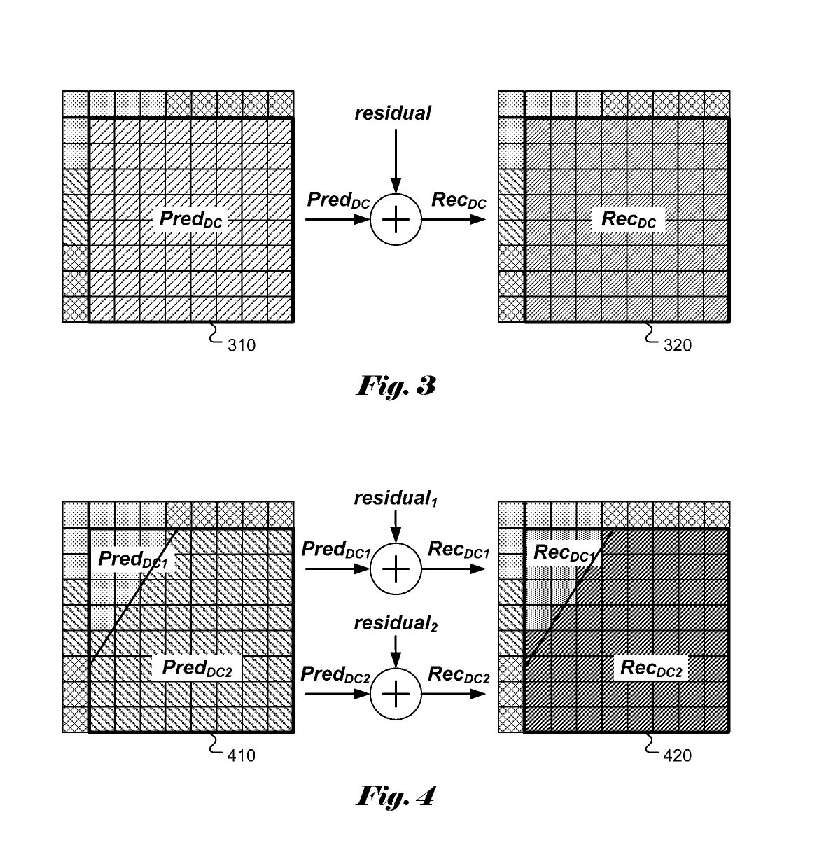

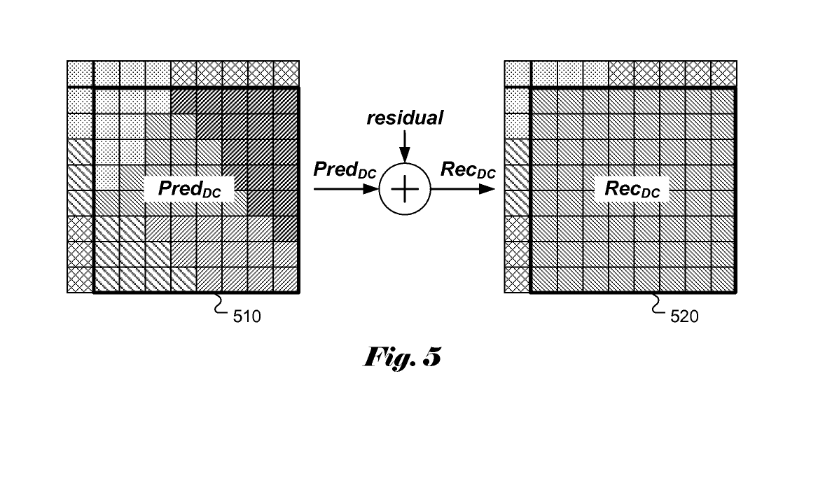

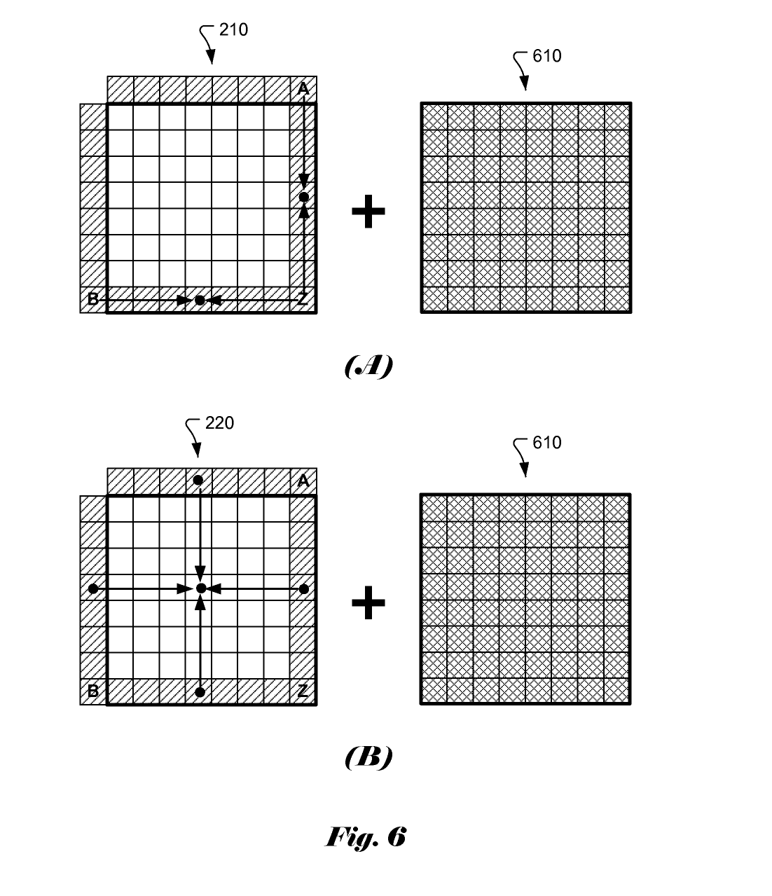

### DETAILED DESCRIPTION

In the existing Simplified Depth Coding (SDC) which is later termed as Segment-wise DC coding (SDC), the input signal to be coded is the mean of the original depth value (d_{orig}) of the depth block and the output is the predicted depth value (d_{pred}) of the depth block which is derived from mean of the predicted depth values for the depth block. There is only one predicted depth value for each segment according to the existing SDC. The predicted depth value is also referred to as DC prediction value, or simply predicted value. The predicted depth samples for the Planar mode block are generated using linear interpolation or bilinear interpolation based on neighboring reconstructed depth values at the top row and the left column directly adjacent to the current depth block. The neighboring reconstructed depth values at the top row and the left column directly adjacent to the current depth block are also available at the decoder side. Therefore the predicted depth samples can be derived at the decoder side. Accordingly, the mean of the predicted depth values can also be derived at the decoder side. At the encoder side the residual index iᵣₑₛᵢ to be coded into the bitstream is derived according to:

iᵣₑₛᵢ=I(d_{orig})−I(d_{pred}), (2)

where I(.) denoting the Index Lookup Table. The derived residual index iᵣₑₛᵢ is then coded using a significance flag and a sign flag. The magnitude of the residual index is coded using ┌log₂ d_{valid}┐ bits, where ┌x┐ is a ceiling function corresponding to the smallest integer not less than x.

At the decoder side, the reconstructed depth value, d_{rec} is derived according to

d_{rec}=I⁻¹(iᵣₑₛᵢ+I(d_{pred})), (3)

where I⁻¹(.) denotes the inverse Index Lookup Table. After the reconstructed depth value is obtained, the reconstructed depth value is used as all depth samples of the reconstructed block/PU. In other words, the whole depth block will have a same reconstructed value for DC mode and Planar mode. There are two reconstructed values for the DMM Mode 1 for the two segments respectively. At the encoder side, the reconstruction process is also performed in the reconstruction loop.

As illustrated above, a same reconstructed value is used for all depth samples in a segment according to the existing SDC. While the method of using a single reconstruction value for each segment is simple, it may cause noticeable distortion in the reconstructed depth blocks. Accordingly, embodiments of the present invention disclose sample-based SDC to improve the performance of depth coding.

First Embodiment. In the first embodiment of the present invention, pixel-based (or sample-based) Simplified Depth Coding (SDC) is disclosed. At the decoder side, the reconstructed residual R_{rec} is derived according to,

R_{rec}=d_{rec}−d_{pred}. (4)

The reconstructed depth values, d_{rec} may correspond to the reconstructed mean of the depth block as in the conventional SDC. Nevertheless, in the present invention, d_{rec} may correspond to other reconstructed depth value that is used by the encoder. For example, d_{rec} may correspond to a reconstructed median or majority of an original depth block.

New reconstructed sample of the current block/PU according to an embodiment of the present invention is then derived by adding the reconstructed residual to each predicted sample, P(x,y). In other words, the reconstructed sample according to the present invention may vary from sample to sample as indicated by the sample location (x,y). An example of the reconstructed sample according to an embodiment of the present invention is shown as follows:

P′(x, y)=R_{rec}+P(x, y). (5)

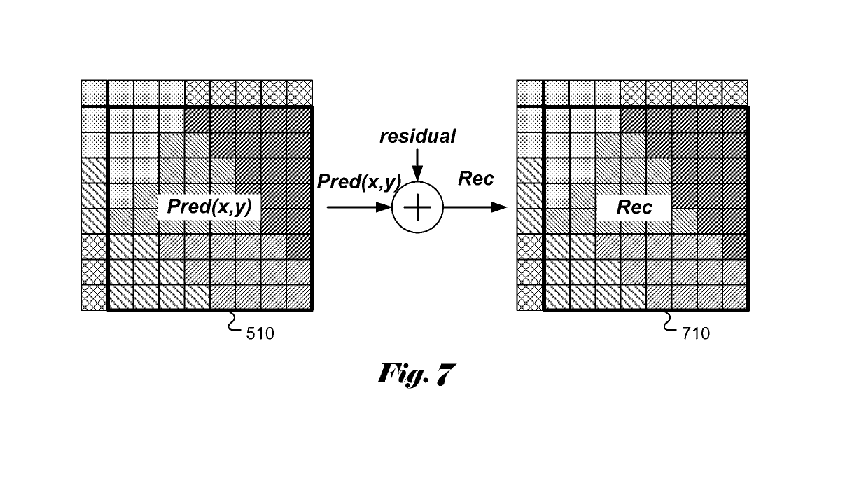

According to the above embodiment, the reconstructed samples, P′(x, y) for the Planar mode is derived according to the prediction samples of the Planar mode plus an offset value (i.e., the reconstructed residual, R_{rec}) as shown in FIG. 6, where the offset value is derived from the residual index. FIG. 6A illustrates that the reconstructed samples for the right column and the bottom row of the current depth block are formed by adding the predictors (210) of the Planar mode to an offset value (610). FIG. 6B illustrates that the reconstructed samples for other sample positions of the current depth block are formed by adding the respective predictors (220) of the Planar mode to the offset value (610). While the Planar mode is used as an example to illustrate the sample-based SDC, the present invention is not limited to the Planar mode. For other Intra modes, the sample-based SDC can also be applied to improve the performance. FIG. 7 illustrates an exemplary reconstruction process for sample-based Simplified Depth Coding (SDC) using the Planar mode according to an embodiment of the present invention. As illustrated in FIG. 7, the reconstructed depth block (710) according to the present invention will be able to reproduce shading within the depth block.

Second Embodiment. According to the second embodiment of the present invention, the offset value is directly derived from the residual value. For example, the offset value R_{rec} is given by

R_{rec}=I⁻¹(iᵣₑₛᵢ), (6)

where I⁻¹ (.) may be the inverse Index Lookup Table or other mapping table. Each prediction sample of the current depth block/PU is then updated with the reconstructed residual, i.e., the reconstructed residual is added to each prediction sample as the reconstructed sample.

Third Embodiment. The third embodiment is based on the first embodiment or the second embodiment, where the types of prediction may be changed from {DC mode, DMM mode 1, Planar mode} to other sets of prediction types. For example, the prediction types may be changed to:

{DC mode, DMM Mode 1, VSP}, or

{Planar mode, DMM Mode 1, VSP}.

Fourth Embodiment. The fourth embodiment is based on the first embodiment or the third embodiment, where the order of the type of prediction might also be changed. Based on this order, a truncated unary code can be used to signal the type selected. For example, the order {Planar mode, DC mode, DMM Mode 1} or {Planar mode, DMM Mode 1, DC mode} can be used.

The performance of a 3D/multi-view video coding system incorporating sample-based Simplified Depth Coding (SDC) according to an embodiment of the present invention is compared to that of a conventional system based on HTM-6.0. The types of prediction include DC mode, DMM Mode 1 and Planar mode. The embodiment according to the present invention uses sample-based SDC, where the reconstructed samples for the Planar mode are derived according to eqn. (5). The performance comparison is based on different sets of test data listed in the first column. The test results of the system incorporating an embodiment of the present invention under the common test conditions and under the all-Intra test conditions are shown in Table 1 and Table 2, respectively. As shown in the tables, the sample-based SDC can achieve 0.2% BD-rate saving for video over total bit-rate in both common test conditions and all-intra test conditions, and 0.2% and 0.1% BD-rate savings for the synthesized view in common test conditions and all-intra test conditions, respectively.

TABLE 1

| | | | | video | video | synth | | | |
|---|---|---|---|---|---|---|---|---|---|
| | | | | PSNR/ | PSNR/ | PSNR/ | | | |
| | | | | video | total | total | enc | dec | ren |
| | video 0 | video 1 | video 2 | bitrate | bitrate | bitrate | time | time | time |
| Balloons | 0.0% | −0.1% | 0.0% | 0.0% | −0.3% | −0.1% | 100.7% | 105.5% | 97.8% |
| Kendo | 0.0% | 0.1% | 0.0% | 0.0% | −0.5% | −0.3% | 100.2% | 100.0% | 96.8% |
| Newspaper_CC | 0.0% | −0.1% | 0.1% | 0.0% | −0.1% | 0.0% | 98.8% | 99.8% | 99.3% |
| GT_Fly | 0.0% | −0.6% | −0.2% | −0.1% | −0.4% | −0.4% | 98.4% | 97.4% | 98.3% |
| Poznan_Hall2 | 0.0% | −0.3% | 0.2% | 0.0% | −0.1% | 0.1% | 99.6% | 101.2% | 99.8% |
| Poznan_Street | 0.0% | 0.0% | 0.1% | 0.0% | −0.3% | −0.3% | 99.0% | 99.1% | 96.6% |
| Undo_Dancer | 0.0% | −0.2% | −0.2% | −0.1% | −0.1% | −0.4% | 99.4% | 102.9% | 98.1% |
| 1024 × 768 | 0.0% | −0.1% | 0.0% | 0.0% | −0.3% | −0.1% | 99.9% | 101.8% | 98.0% |
| 1920 × 1088 | 0.0% | −0.3% | 0.0% | 0.0% | −0.2% | −0.2% | 99.1% | 100.2% | 98.2% |
| average | 0.0% | −0.2% | 0.0% | 0.0% | −0.2% | −0.2% | 99.4% | 100.8% | 98.1% |

TABLE 2

| | | | | video | video | synth | | | |
|---|---|---|---|---|---|---|---|---|---|
| | | | | PSNR/ | PSNR/ | PSNR/ | | | |
| | | | | video | total | total | | | ren |
| | video 0 | video 1 | video 2 | bitrate | bitrate | bitrate | enc time | dec time | time |
| Balloons | 0.0% | 0.0% | 0.0% | 0.0% | −0.3% | 0.0% | 101.9% | 99.8% | 96.7% |
| Kendo | 0.0% | 0.0% | 0.0% | 0.0% | −0.3% | 0.0% | 101.7% | 103.1% | 101.5% |
| Newspaper_CC | 0.0% | 0.0% | 0.0% | 0.0% | −0.1% | 0.1% | 101.3% | 102.3% | 103.9% |
| GT_Fly | 0.0% | 0.0% | 0.0% | 0.0% | −0.2% | −0.2% | 97.8% | 100.6% | 97.1% |
| Poznan_Hall2 | 0.0% | 0.0% | 0.0% | 0.0% | 0.0% | 0.1% | 102.0% | 95.9% | 102.1% |
| Poznan_Street | 0.0% | 0.0% | 0.0% | 0.0% | −0.2% | −0.2% | 100.2% | 97.2% | 97.0% |
| Undo_Dancer | 0.0% | 0.0% | 0.0% | 0.0% | 0.0% | −0.1% | 99.5% | 99.3% | 96.8% |
| 1024 × 768 | 0.0% | 0.0% | 0.0% | 0.0% | −0.2% | 0.0% | 101.6% | 101.7% | 100.7% |
| 1920 × 1088 | 0.0% | 0.0% | 0.0% | 0.0% | −0.1% | −0.1% | 99.9% | 98.3% | 98.2% |
| average | 0.0% | 0.0% | 0.0% | 0.0% | −0.2% | −0.1% | 100.6% | 99.7% | 99.3% |

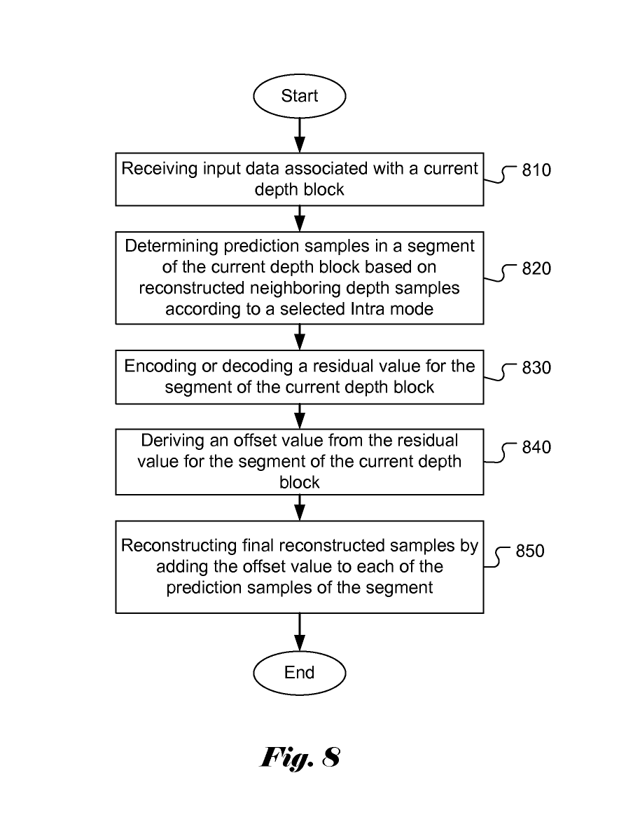

FIG. 8 illustrates an exemplary flowchart of sample-based Simplified Depth Coding (SDC) for depth data using Intra modes according to an embodiment of the present invention. The system receives input data associated with a current depth block as shown in step 810. For encoding, the input data associated with the depth block corresponds to the depth samples to be coded. For decoding, the input data associated with the current depth block corresponds to the coded depth data to be decoded. The input data associated with the current depth block may be retrieved from memory (e.g., computer memory, buffer (RAM or DRAM) or other media) or from a processor. Prediction samples for the current depth block are then determined based on reconstructed neighboring depth samples according to a selected Intra mode as shown in step 820. A residual value (of each segment) of the current depth block is encoded or decoded, and an offset value (of each segment) is then derived from the residual value (using Eqn. 4 as an example) as shown in step 830. The reconstructed samples are derived by adding the offset value to the prediction samples (for each segment) as shown in step 840.

The flowchart shown above is intended to illustrate an example of sample-based Simplified Depth Coding (SDC). A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of Intra coding for a depth block in a three-dimensional coding system, the method comprising:
receiving input data associated with a current depth block;
determining prediction samples in a segment of the current depth block based on reconstructed neighboring depth samples according to a selected Intra mode;
encoding or decoding a residual value for the segment of the current depth block;
deriving an offset value from the residual value for the segment of the current depth block; and
reconstructing final reconstructed samples by adding the offset value to each of the prediction samples of the segment.

2. The method of claim 1, wherein the offset value corresponds to a difference between a reconstructed depth value and a predicted depth value for the segment of the current depth block.

3. The method of claim 1, wherein the offset value is derived from the residual value, wherein the residual value is derived implicitly at a decoder side or the residual value is transmitted in a bitstream.

4. The method of claim 1, wherein deriving the offset value from the residual value comprises determining a residual index according to an inverse Lookup Table.

5. The method of claim 1, wherein the selected Intra mode corresponds to Planar mode, the prediction samples are determined using linear interpolation and bilinear interpolation from the reconstructed neighboring depth samples of the current depth block according to the Planar mode, and the offset value is derived from the residual value or a residual index.

6. The method of claim 1, wherein the selected Intra mode is selected from a set of Intra modes.

7. The method of claim 6, wherein selection of the selected Intra mode from the set of Intra modes is signalled in a bitstream.

8. The method of claim 7, wherein the set of Intra modes consists of DC (Direct Current) mode, DMM (Depth Modelling Modes) Mode 1 and Planar mode.

9. The method of claim 7, wherein the set of Intra modes consists of DC mode, DMM Mode 1 and VSP mode.

10. The method of claim 7, wherein the set of Intra modes consists of Planar mode, DMM Mode 1 and VSP mode.

11. The method of claim 7, wherein a truncated unary code is used to indicate the selected Intra mode from the set of Intra modes.

12. The method of claim 1, wherein the current depth block comprises only one segment when the selected Intra mode is DC mode or Planer mode.

13. The method of claim 1, wherein the current depth block comprises only one segment when the selected Intra mode is selected from the Intra modes in High Efficient Video Coding (HEVC).

14. An apparatus for Intra coding of a depth block in a three-dimensional coding system, the apparatus comprising one or more electronic circuits, wherein said one or more electronic circuits are configured to:
receive input data associated with a current depth block;
determine prediction samples for a segment of the current depth block based on reconstructed neighboring depth samples according to a selected Intra mode;
encoding or decoding a residual value for the segment of the current depth block;
deriving an offset value from the residual value for the segment of the current depth block; and
reconstructing final reconstructed samples by adding the offset value to each of the prediction samples of the segment.
